(19) United States
(12) Patent Application Publication
(10) Pub. No.: US 2023/0281584 A1
(43) Pub. Date: Sep. 7, 2023

(54) Systems and Methods for Product Purchases and Non-Fungible Tokens

(71) Applicant: National Entertainment Collectibles Association, Inc., Hillside, NJ (US)

(72) Inventor: Joel Weinshanker, Las Vegas, NV (US)

(73) Assignee: National Entertainment Collectibles Association, Inc., Hillside, NJ (US)

(21) Appl. No.: 18/117,962

(22) Filed: Mar. 6, 2023

Related U.S. Application Data
(60) Provisional application No. 63/317,421, filed on Mar. 7, 2022.

(51) Int. Cl. G06Q 20/12; G06Q 20/32

(52) U.S. Cl. CPC G06Q 20/1235; G06Q 20/322; G06Q 2220/00

(57) ABSTRACT

Systems and methods for product purchases/auctions and non-fungible tokens (NFTs) are provided. A computer-based, digital platform allows a user to easily purchase or participate in auctions of physical products (such as a collectible, memorabilia, unique artwork, etc.), and automatically generates and administers NFTs associated with the purchase/auction of such products. The products can be purchased/auctioned via an online platform that can be accessed by a user’s computer system or mobile device. One or more vouchers can be redeemed at a desired location and can be used to access the platform to effectuate the purchase of a product, enter into an auction for the product, or to redeem a gifted product. The NFT provides proof of ownership of the product, and is linked to the product by the system.

### RELATED APPLICATIONS

The present application claims the benefit of priority to U.S. Provisional Application No. 63/317,421, filed on Mar. 7, 2022, the entire disclosure of which is incorporated by reference herein.

### TECHNICAL FIELD

The present disclosure relates generally to the field of electronic commerce. More particularly, the present disclosure relates to systems and methods for product purchases and non-fungible tokens (NFTs).

### RELATED ART

In the electronic commerce field, blockchain-based solutions have gained increased interest. NFTs are a type of blockchain-based technology, wherein a non-interchangeable unit of data is stored on a blockchain that can be sold or traded, and which is uniquely identifiable. Often, NFTs are associated with digital assets such as photos, videos, and audio files. NFTs provide a certificate of authenticity or proof of ownership of an asset.

It would be beneficial to extend the usage of NFTs in connection with the sale and purchase of non-digital assets, such as physical products, collectible items, etc. It would also be beneficial to provide a digital platform that facilitates both the purchase or sale of assets (such as non-digital assets), but automatically issues and maintains NFTs associated with the purchase or sale of such assets in a convenient, easy-to-access digital platform. Accordingly, what would be desirable are systems and methods for product purchases and NFTs, which addresses the foregoing and other needs.

### SUMMARY

The present disclosure relates systems and methods for product purchases and NFTs. The system provides a computer-based, digital platform that allows a user to easily purchase physical products (such as a collectible, memorabilia, unique artwork, etc.), and which automatically generates and administers NFTs associated with the purchase of such products. The products can be purchased via an online (e.g., web-based) platform that can be accessed by a user’s computer system or mobile device (e.g., smart phone). One or more vouchers (e.g., in the form of a voucher card, QR code, etc.) can be redeemed at a desired location (e.g., at a point of sale), and can be used to access the platform to effectuate the purchase of a product, enter into an auction for the product, or to redeem a gifted product (e.g., gifted to the recipient by another user of the system). When the product has been purchased or redeemed and the system, an NFT is automatically generated and administered by the system. The NFT provides proof of ownership of the product, and is linked to the product by the system.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating processing steps carried out by the system of the present disclosure for purchasing of a product and automatically generating and administering an NFT associated with the product;

FIG. 3 is flowchart illustrating processing steps carried out by the system of the present disclosure for participating in an auction of a product and automatically generating and administering an NFT associated with the auctioned product;

FIG. 4 is flowchart illustrating processing steps carried out by the system of the present disclosure for purchasing a product using a voucher card and automatically generating and administering an NFT associated with the product;

FIG. 5 is a flowchart illustrating processing steps carried out by the system of the present disclosure for purchasing a product using a QR code and automatically generating and administering an NFT associated with the product; and

FIG. 6 is a flowchart illustrating processing steps carried out by the system of the present disclosure for redeeming a gifted product and automatically generating and administering an NFT associated with the gifted product.

### DETAILED DESCRIPTION

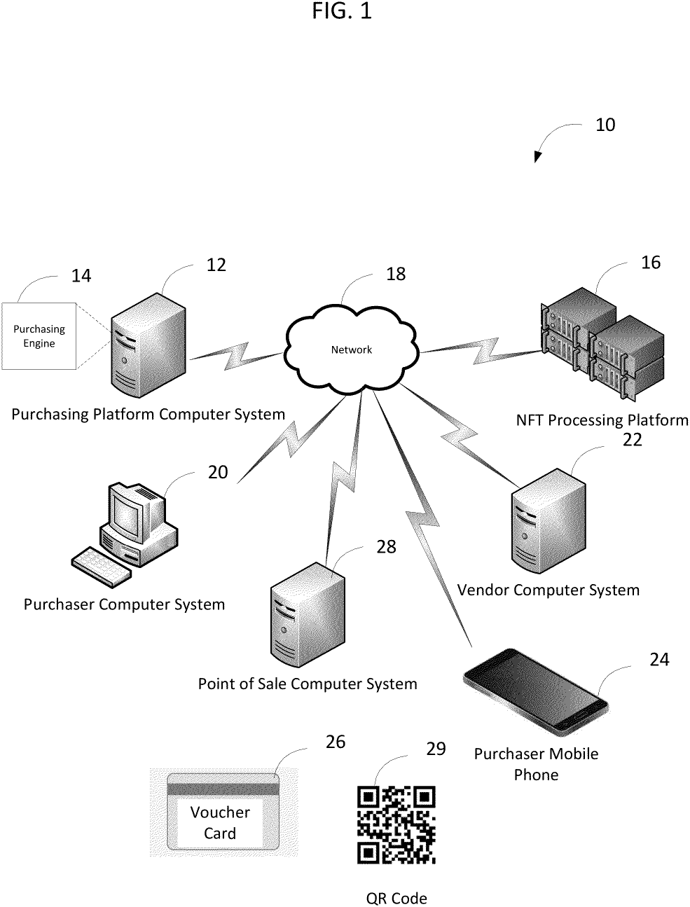

The present disclosure relates to machine learning systems and methods for product purchases and NFTs, as described in detail below in connection with FIGS. 1-6. As will be described in greater detail below, the system allows consumer purchasers of physical goods to use an NFT to securely validate ownership of the physical goods purchased on the platform. The system has particular use in the collectible goods market, which is ripe with counterfeits from unverified sources. Each product purchased using the system is automatically linked to a specific NFT which securely validates ownership of the purchased product. The system also provides consumers with a way to sell products from their collections to other consumers.

FIG. 1 is a diagram illustrating the system of the present disclosure, indicated generally at 10 (also referred to herein as a “platform”). The system 10 includes a purchasing platform computer system 12 that executes a specially-programmed purchasing engine or software module 14 that provides the features disclosed herein. The system 12 communicates with one or more devices via a network 18 (which could include the Internet, a local area network (LAN), a wide area network (WAN), etc.) including an NFT processing platform 16, a purchaser computer system 20, a vendor computer system 22, a purchaser mobile device 24, and a point of sale computer system 28. The NFT processing platform 16 generates NFTs for usage by the system 12, and could include the Polygon blockchain NFT or any other suitable NFT. It is noted that the system 12 need not communicate with the NFT processing platform 16 to generate NFTs, and could instead be programmed to generate the NFTs discussed herein. The NFT processing platform 16 could also be utilized to verify blockchain-based NFT transactions executed by the system 12, if desired. In such circumstances, the platform 16 could include a plurality of networked, peer-to-peer computer systems typically utilized in blockchain transactions.

The purchaser computer system 20 could be a general-purpose computer system that provides web-based access for a purchaser to the system 12, and/or it could execute customized “front-end” software application executed by the system 20 that allows the purchaser to access the system 12. The purchaser could also access the computer system 20 using a mobile phone 24, as described in detail below. For example, the mobile phone 24 could be utilized to scan a QR code 29 to access the system 12, as will be described in greater detail below. The vendor computer system 22 allows a vendor of a product to communicate with the system 12 in order to provide information about the product, coordinate shipping of the product, coordinate electronic billing and payments to the vendor, manage products being sold on the platform, etc. The point of sale computer system 28 could be installed at a point of sale (e.g., at a retail store) and can be used to activate one or more voucher cards 26 for use in purchasing a product on the system 12, as described in detail below.

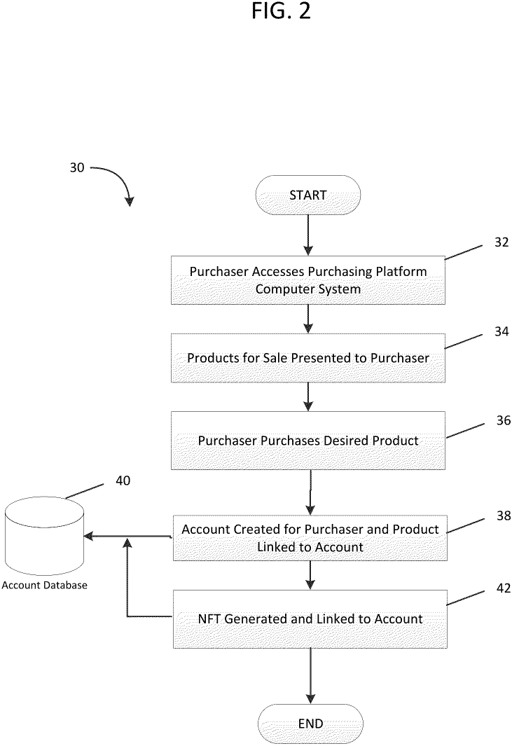

The purchasing engine 14 could be embodied as non-transitory, computer-readable instructions stored on a memory of the system 12 and executed by a processor of the system 12, and could be coded in any suitable high- or low-level programming language including, but not limited to, C, C++, C#, Java, Javascript, Python, or any other suitable programming language. Alternatively, the engine 14 could be embodied as a customized hardware processor, such as an application-specific integrated circuit (ASIC), field-programmable gate array (FPGA), or other customized or embedded hardware processor. It is further noted that the functions provided by the engine 14 (described in greater detail below in connection with FIGS. 2-6) could be executed on more than one computer system, and/or on a “cloud” computing environment, if desired.

FIG. 2 is a flowchart illustrating processing steps (indicated generally at 30 carried out by the system of the present disclosure for purchasing of a product and automatically generating and administering an NFT associated with the product. In step 32, a purchaser accesses the computer system 12 using one or more devices, such as the purchaser computer system 20 or the mobile phone 24. Access to the system could be controlled by way of a user account and password, if desired. In step 34, the system 12 presents information about products that are currently available for purchase (e.g., from a vendor operating the vendor computer system 22). Examples of such products include, but are not limited to, physical products, memorabilia, collectables, artwork, etc. Information about such products could be presented in a web-based graphical user interface, customized interface, etc. In step 36, the purchaser purchases a desired product using the system 12 (e.g., using a credit card, a PAYPAL account, APPLE PAY, or another type of e-commerce payment system and/or using cryptocurrency (e.g., Bitcoin, Ethereum, etc.). In step 38, the system creates a creates an account for the purchaser and automatically links the purchased product to the user’s account. This information is stored in an account database 40, which could be hosted by the system 12 or another computer system in communication with the system 12. In step 42, the system 12 automatically generates an NFT associated with the purchased product and links the NFT to the user’s account. The NFT could be generated by the system 12 itself, or by the NFT platform 16 and transmitted to the system 12. Also, the NFT platform 16 could be updated with information relating to the NFT and supplied by the system 12. Information about the NFT and the link to the account is stored in the database 40.

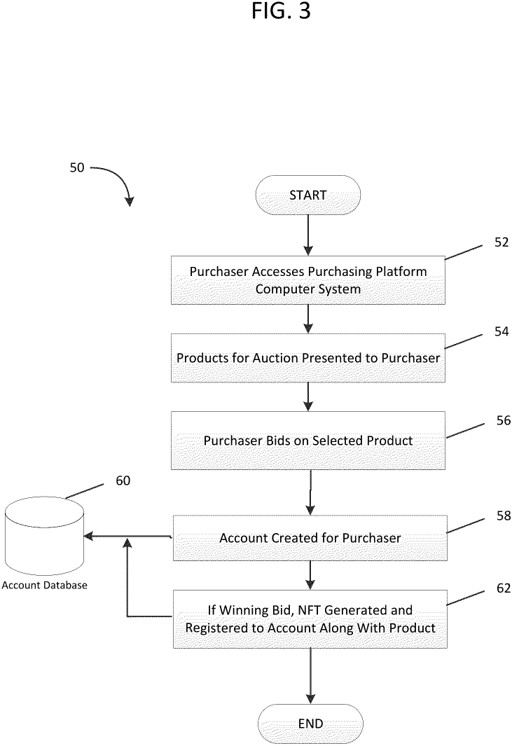

FIG. 3 is flowchart illustrating processing steps (indicated generally at 50) carried out by the system of the present disclosure for participating in an auction of a product and automatically generating and administering an NFT associated with the auctioned product. In step 52, a purchaser accesses the computer system 12 using one or more devices, such as the purchaser computer system 20 or the mobile phone 24. Access to the system could be controlled by way of a user account and password, if desired. In step 54, the system 12 presents information about products that are currently available for auction (e.g., from a vendor operating the vendor computer system 22). Examples of such products include, but are not limited to, physical products, memorabilia, collectables, artwork, etc. Information about such products could be presented in a web-based graphical user interface, customized interface, etc. In step 56, the purchaser bids on a selected product, and the auction is conducted. In step 58, the system creates a creates an account for the purchaser. This information is stored in an account database 60, which could be hosted by the system 12 or another computer system in communication with the system 12. If the purchaser wins the auction, steps 62 occurs, wherein the purchaser purchases the auctioned product using the system 12 (e.g., using a credit card, a PAYPAL account, APPLE PAY, or another type of e-commerce payment system and/or using cryptocurrency (e.g., Bitcoin, Ethereum, etc.). Also, in step 62, the system 12 automatically generates an NFT associated with the auctioned product and links the NFT to the user’s account. The NFT could be generated by the system 12 itself, or by the NFT platform 16 and transmitted to the system 12. Also, the NFT platform 16 could be updated with information relating to the NFT and supplied by the system 12. Information about the NFT and the link to the account is stored in the database 60.

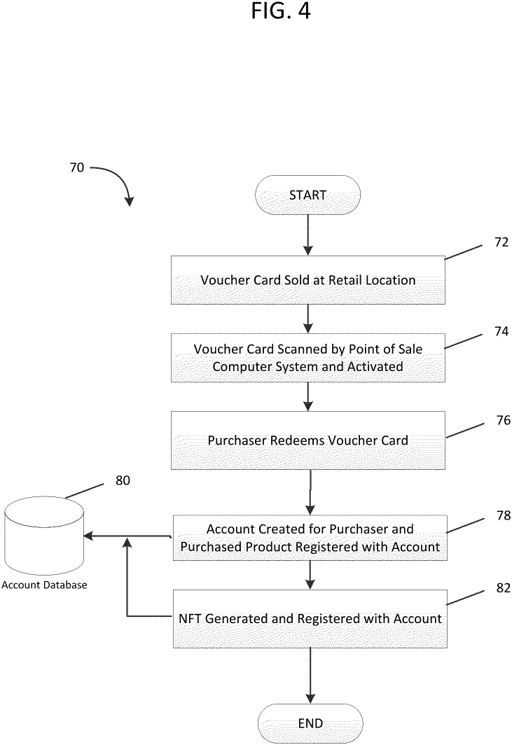

FIG. 4 is flowchart illustrating processing steps (indicated generally at 70) carried out by the system of the present disclosure for purchasing a product using a voucher card and automatically generating and administering an NFT associated with the product. In step 72, a purchaser purchases a voucher card (such as the voucher card 26 of FIG. 1) at a point of sale (e.g., at a retail store). In step 74, the voucher card is scanned by the point of sale computer system 26 to activate the voucher card, and information about the activated card is transmitted to the system 12. In step 76, the purchaser accesses the computer system 12 using one or more devices, such as the purchaser computer system 20 or the mobile phone 24, and provides a unique code to the system 12 (which could be revealed by scratching a protective coating off of the back of the voucher card 26. In step 78, the purchaser purchases a product associated with the voucher card using the system 12 (e.g., using a credit card, a PAYPAL account, APPLE PAY, or another type of e-commerce payment system and/or using cryptocurrency (e.g., Bitcoin, Ethereum, etc.), and the system creates a creates an account for the purchaser and automatically links the purchased product to the user’s account. This information is stored in an account database 80, which could be hosted by the system 12 or another computer system in communication with the system 12. In step 82, the system 12 automatically generates an NFT associated with the purchased product and links the NFT to the user’s account. The NFT could be generated by the system 12 itself, or by the NFT platform 16 and transmitted to the system 12. Also, the NFT platform 16 could be updated with information relating to the NFT and supplied by the system 12. Information about the NFT and the link to the account is stored in the database 80.

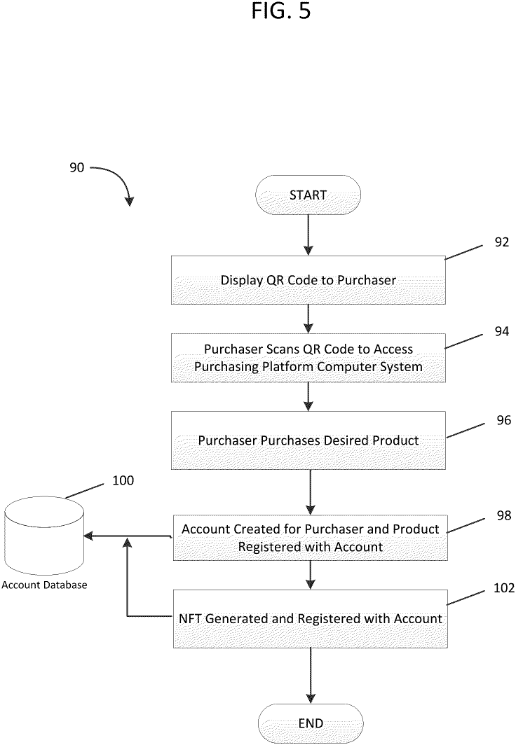

FIG. 5 is a flowchart illustrating processing steps (indicated generally at 90) carried out by the system of the present disclosure for purchasing a product using a QR code and automatically generating and administering an NFT associated with the product. In step 92, a QR code is displayed to the purchaser (e.g., displayed digitally on a computer screen, in a printed advertisement, etc.). In step 94, the purchaser scans the QR code using the camera of the mobile phone 24. When scanned, the QR code causes the phone 24 to display a link that the user can select in order to provide access to the system 12 (e.g., a hypertext link to a web-based front end for accessing the system 12). In step 96, the purchaser accesses the computer system 12 and purchases a desired product using the system 12 (e.g., using a credit card, a PAYPAL account, APPLE PAY, or another type of e-commerce payment system and/or using cryptocurrency (e.g., Bitcoin, Ethereum, etc.). The desired product could be linked to the QR code such that the product is automatically displayed by the system 12 when the user scans the QR code and accesses the system 12 via the link described above. In step 98, the system creates a creates an account for the purchaser and automatically links the purchased product to the user’s account. This information is stored in an account database 100, which could be hosted by the system 12 or another computer system in communication with the system 12. In step 102, the system 12 automatically generates an NFT associated with the purchased product and links the NFT to the user’s account. The NFT could be generated by the system 12 itself, or by the NFT platform 16 and transmitted to the system 12. Also, the NFT platform 16 could be updated with information relating to the NFT and supplied by the system 12. Information about the NFT and the link to the account is stored in the database 100.

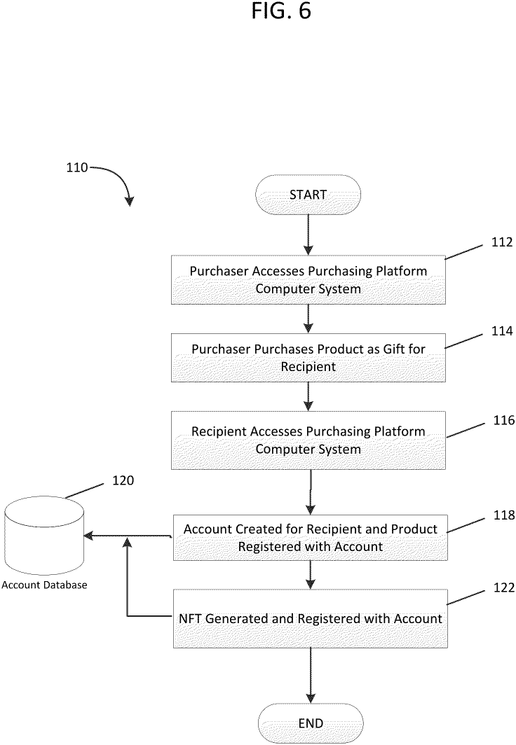

FIG. 6 is a flowchart illustrating processing steps (indicated generally at 110) carried out by the system of the present disclosure for redeeming a gifted product and automatically generating and administering an NFT associated with the gifted product. In step 112, a purchaser accesses the system 12 using the computer system 20 or the mobile phone 24. In step 114, the purchaser purchases a product as a gift for the recipient. A gift card or gift message (e.g., electronic message) could be generated and sent to the recipient, indicating that a gift has been purchased for the recipient. In step 116, the recipient accesses the computer system 12 and redeems the gifted product. In step 116, the system creates an account for the recipient and automatically links the gifted product to the recipient’s account. This information is stored in an account database 120, which could be hosted by the system 12 or another computer system in communication with the system 12. In step 122, the system 12 automatically generates an NFT associated with the gifted product and links the NFT to the recipient’s account. The NFT could be generated by the system 12 itself, or by the NFT platform 16 and transmitted to the system 12. Also, the NFT platform 16 could be updated with information relating to the NFT and supplied by the system 12. Information about the NFT and the link to the account is stored in the database 120.

It is noted that the system 10 can be used to sell a product that is already produced, or the right to receive a predetermined number of future releases from a specific product line. Additionally, the system can be used to sell specific products that are known to the customer at the time of purchase, or as part of a collectible products model, in which a product or products are randomly selected from a pool of products, with different products in the pool appearing with different rarity, using a predetermined collation formula assigning a specific rarity to each product in the pool. In the collectible products model, the exact product or products are revealed to the consumer in their collection on the platform after the token is registered on the platform.

Upon purchase, the customer is given the option to either have the product shipped to an address of their choosing, or stored by the vendor for a predetermined amount of time, the cost being included in the price at purchase. It is also noted that the system provides a method for a vendor to sell physical goods along with the corresponding token they’ve purchased using the platform to other consumers via an auction or direct sale, using the token to validate their ownership. The system creates an account for the secondary market purchaser and transfers the token to their account, thereby creating a clear chain of title for the purchased product. The platform can use the Polygon blockchain to identify and validate such secondary market sales.

It is further noted that the system can provide the user with a cryptocurrency wallet to store the tokens corresponding to the products in their collection. The system could also provide a customer with a dashboard to view their collection of products purchased through the platform, showing which products are being shipped to the customer and which products are being stored for the customer, and how much time is left on the storage term. This collection can be used by the user to create a listing to sell products to other consumers. The dashboard can also display customer service information for the product vendor who made the product or products in the consumer’s collection.

Using the system, retailers can apply to sell voucher cards for platform products at their retail locations. The system provides participating retail partners with a dashboard to view sales of product or products at its retail locations via the platform. Additionally, product vendors can apply to list their product for sale on the system and via voucher cards at retail locations for participating retail partners. The system provides participating product vendors with a dashboard to view sales of products via the platform. This dashboard can show participating product vendors which products to ship to customers, which products to store for customers, and how much time is left on the storage term. Further, the system can provide a notification to the product vendor with a link to the transaction on the system. The system can export CSV files of transaction reports for the product vendor to import into their sales and inventory management systems.

When a consumer purchases a product or products from a participating product vendor on the system, the system receives a predetermined share of the transaction as a platform service fee. If such sale occurs via a voucher card at a participating retailer’s retail location, the retailer receives a share of the transaction as a retailer service fee. The product vendor receives the remainder of the transaction. For an additional predetermined platform service fee, participating product vendors can elect to have their products stored by the platform service provider, for subsequent shipment to the consumer or storage of the product for the consumer on behalf of the product vendor. When a consumer sells a product from their collection on the platform to another consumer, the system receives a predetermined share of the transaction as a platform service fee. The system may offer participating product vendors and participating retailers a share of such secondary market sales made by consumers on the system, for products corresponding to the specific product vendor or retailer, if the product in question was originally sold at a retailer’s retail location via a voucher card, as applicable. It is additionally noted that the system can include security features including but not limited to two-factor authentication to secure access to the system, including sales by consumers to other consumers on the system. The tokens on the system and all related transactions are securely validated against a blockchain, such as the Polygon blockchain or other suitable blockchain.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A system for product purchases and non-fungible tokens (NFTs), comprising:
a purchasing platform computing system in communication with a purchaser computer system; and
a purchasing software module executed by the purchasing platform computer system, the purchasing software module causing the purchasing platform computing system to:
display information on the purchase computer system relating to a product currently available for purchase;
allowing a user of the purchaser computer system to electronically purchase the product;
automatically generating an NFT in response to electronic purchasing of the product by the user, the NFT validating ownership by the user of the purchased product; and
linking the NFT with an account associated with the user, the NFT electronically accessible by the user.

2. The system of claim 1, wherein the purchaser computer system comprises a mobile phone.

3. The system of claim 1, further comprising a voucher redeemable by the user, the voucher allowing access to the purchasing platform computer system for purchasing of the product.

4. The system of claim 3, wherein the voucher comprises a voucher card redeemable by the user.

5. The system of claim 1, further comprising a Quick Response (QR) code scannable by the purchaser computer system, the QR code allowing access to the purchasing platform computer system for purchasing of the product.

6. The system of claim 1, wherein the purchasing platform computing system communicates with one or more of a vendor computer system or a point of sale computer system.

7. The system of claim 1, wherein the product is redeemable by the user as a pre-purchased gift.

8. A method for product purchases and non-fungible tokens (NFTs), comprising the steps of:
display information on a purchase computer system relating to a product currently available for purchase via a purchasing platform computing system;
allowing a user of the purchaser computer system to electronically purchase the product;
automatically generating an NFT in response to electronic purchasing of the product by the user, the NFT validating ownership by the user of the purchased product; and
linking the NFT with an account associated with the user, the NFT electronically accessible by the user.

9. The method of claim 8, further comprising providing a voucher redeemable by the user, the voucher allowing access to the purchasing platform computer system for purchasing of the product.

10. The method of claim 9, wherein the voucher comprises a voucher card redeemable by the user.

11. The method of claim 8, further comprising providing a Quick Response (QR) code scannable by the purchaser computer system, the QR code allowing access to the purchasing platform computer system for purchasing of the product.

12. The method of claim 8, further comprising allowing the user to redeem the product as a pre-purchased gift.

13. A system for product auctions and non-fungible tokens (NFTs), comprising:
a purchasing platform computing system in communication with a purchaser computer system; and
a purchasing software module executed by the purchasing platform computer system, the purchasing software module causing the purchasing platform computing system to:
display information on the purchase computer system relating to a product currently available for auction;
allowing a user of the purchaser computer system to electronically participate in the auction;
automatically generating an NFT in response to winning by the user of the auction relating to the product, the NFT validating ownership by the user of the auctioned product; and
linking the NFT with an account associated with the user, the NFT electronically accessible by the user.

14. The system of claim 13, wherein the purchaser computer system comprises a mobile phone.

15. The system of claim 13, wherein the access to the auction is secured by a user account and password.

16. The system of claim 1, wherein the purchasing platform computing system communicates with one or more of a vendor computer system.

17. A method for product auctions and non-fungible tokens (NFTs), comprising the steps of:
display information on a purchase computer system relating to a product currently available for auction via a purchasing platform computing system;
allowing a user of the purchaser computer system to electronically participate in the auction;
automatically generating an NFT in response to winning by the user of the auction relating to the product, the NFT validating ownership by the user of the auctioned product; and
linking the NFT with an account associated with the user, the NFT electronically accessible by the user.

18. The method of claim 17, further comprising securing access to the auction using a user account and password.

19. The method of claim 17, further comprising electronically obtaining and presenting information relating to the product available for auction from a vendor computer system in communication with the purchasing platform computing system.

20. A method for product purchases and non-fungible tokens (NFTs), comprising:
providing a voucher for purchase at a point of sale;
allowing a purchaser to purchase the voucher at the point of sale; and
processing the voucher using a point of sale computer system to electronically activate the voucher, the voucher redeemable to: (1) purchase a product or participate in an auction associated with the product; and (2) redeem an electronically-generated NFT associated with purchase or auctioning of the product, the NFT validating ownership of the product.
